(19) United States
(12) Patent Application Publication
(10) Pub. No.: US 2025/0084690 A1
(43) Pub. Date: Mar. 13, 2025

(54) VEHICULAR INTERIOR CABIN MONITORING SYSTEM WITH WATER SENSOR

(71) Applicant: Magna Electronics Inc., Auburn Hills, MI (US)

(72) Inventor: Bishnu Raveendran, Rochester, MI (US)

(21) Appl. No.: 18/823,777

(22) Filed: Sep. 4, 2024

Related U.S. Application Data
(60) Provisional application No. 63/589,765, filed on Oct. 12, 2023.
(60) Provisional application No. 63/581,336, filed on Sep. 8, 2023.

(51) Int. Cl. E05F 15/71; B60Q 1/50; B60Q 5/00; B62D 25/24; G08B 21/20

(52) U.S. Cl. CPC E05F 15/71; B60Q 1/543; B60Q 5/005; B62D 25/24; E05Y 2900/542; E05Y 2900/55; G08B 21/20

(57) ABSTRACT

A vehicular sensing system includes at least one water sensor disposed at an interior of a vehicle. An electronic control unit (ECU) includes electronic circuitry and associated software. Responsive to receiving at the ECU an output of the at least one water sensor, presence of water within the equipped vehicle is determined. Responsive to determination of presence of water within the equipped vehicle, an alert indicating presence of water within the interior of the equipped vehicle is generated. Responsive to determining that an occupant is not present within the equipped vehicle when presence of water is determined within the equipped vehicle, a function of the equipped vehicle may be controlled and/or an alert may be communicated to a user device of a user associated with the equipped vehicle.

### CROSS REFERENCE TO RELATED APPLICATIONS

The present application claims the filing benefits of U.S. provisional application Ser. No. 63/589,765, filed Oct. 12, 2023, and U.S. provisional application Ser. No. 63/581,336, filed Sep. 8, 2023, which are hereby incorporated herein by reference in their entireties.

### FIELD OF THE INVENTION

The present invention relates generally to a vehicle sensing system for a vehicle and, more particularly, to a vehicle sensing system that utilizes one or more sensors at a vehicle.

### BACKGROUND OF THE INVENTION

Modern vehicles contain many components that are sensitive to water damage, including sophisticated electronics. Accidents such as windows and sunroofs being left open can easily cause water to collect within the interior of the vehicle and damage these components.

### SUMMARY OF THE INVENTION

A vehicular sensing system includes at least one water sensor or moisture sensor disposed at an interior of a vehicle equipped with the vehicular sensing system. The system includes an electronic control unit (ECU) with electronic circuitry and associated software. The vehicular sensing system, responsive to an output of the at least one water sensor, determines presence of water at the at least one water sensor. Responsive to determination of presence of water within the equipped vehicle, an alert indicating presence of water within the interior of the equipped vehicle is generated. Optionally, responsive to determining that an occupant is not present within the equipped vehicle when presence of water is determined within the equipped vehicle, a function of the equipped vehicle may be controlled and/or an alert may be communicated to a user device of a user associated with the equipped vehicle. Optionally, responsive to determination of presence of water within the equipped vehicle, a drain may be adjusted or opened to drain water from within the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates water sensors;

FIG. 2 is a side view of a vehicle with multiple water sensors;

FIG. 3 is a flowchart for the sensing system of FIG. 1;

FIG. 4 is a cross-section view of a first drain for a vehicular flood mitigation system; and

FIG. 5 is a cross-section view of a second drain for a vehicular flood mitigation system.

### DESCRIPTION OF THE PREFERRED EMBODIMENTS

A vehicle sensing system and/or alert system operates to capture sensor data interior of a vehicle, such as to detect the presence of water in an interior or cabin of the vehicle. The sensing system includes a data processor or data processing system that is operable to receive sensor data from one or more sensors and provide an alert or notification to a user or owner of the vehicle.

Referring now to the drawings and the illustrative embodiments depicted therein, a vehicle 10 includes a sensing system 12 that includes at least one interior sensor, such as one or more water sensors 14 disposed in the cabin of the vehicle (and the system may optionally include multiple sensors elsewhere within the vehicle, such as a sensor within the engine compartment of the vehicle, within a trunk of the vehicle, etc.), which capture sensor data to detect the presence of water in the vicinity of the respective sensor. The sensing system 12 includes a control or electronic control unit (ECU) 16 having electronic circuitry and associated software. The electronic circuitry includes a data processor that is operable to process sensor data captured by the sensor or sensors 14, whereby the ECU 16 may detect or determine the presence of water or other liquids at or near the sensor 14. The data transfer or signal communication from the camera to the ECU 16 may comprise any suitable data or communication link of the equipped vehicle, such as a vehicle network bus or the like.

Water and other liquids can cause expensive damage to the interior of vehicles. For example, water can cause electronics to fail and ruin upholstery and other materials within the vehicle. In addition, it is possible for such damage to occur suddenly and without knowledge of the owner of the vehicle (e.g., when windows or a sunroof are mistakenly left open during inclement weather). Implementations herein include a sensing system that includes one or more water sensors that detect presence of water within the cabin or other areas of the vehicle and generates an alert or notification accordingly. The water sensor may comprise, for example, a spot leak detector, a hydroscopic tape-based (HTB) sensor, a rope-style sensor, an optical water sensor, a capacitance liquid level sensor, a tuning fork level sensor, a diaphragm liquid level sensor, a float water level sensor, an ultrasonic liquid level sensor, or a radar level gauge, or other suitable water presence detection device or water level sensing device. The sensor may generate an output when the sensor is in the presence of water or when the sensor is in contact with water, such as when water gets to a sufficient level to submerge or at least partially submerge one or more leads or contacts of the sensor.

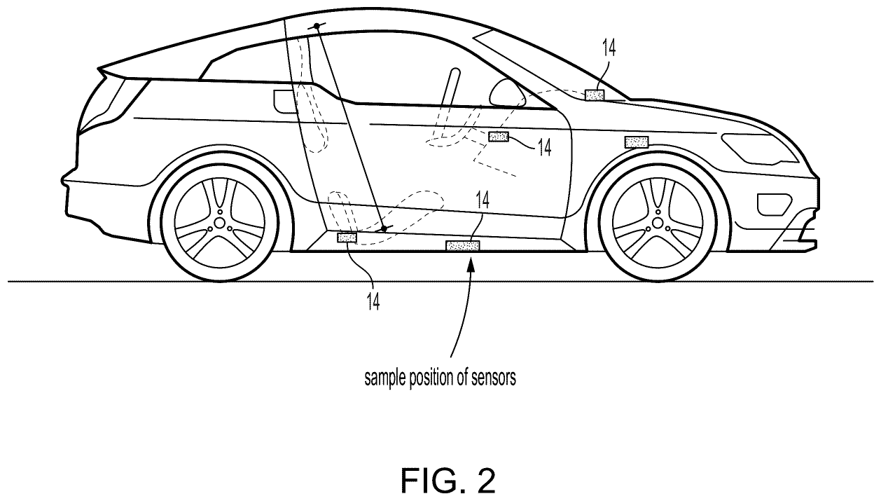

Referring now to FIG. 2, the sensing system 12 may include one or more water or liquid or flood sensors 12 that detect the presence of water or other liquid when the liquid comes into contact with a part of the sensor (e.g., contacts or leads of the sensor). The sensors 14 may be located at a variety of locations around the vehicle. For example, the sensors may be located at a driver instrument panel, a center panel (or other panels near cup holders), along the floorboards (e.g., below floor mats), within the trunk, below one or more seats, or at any other critical area prone to or susceptible to water damage.

Each sensor 14 may be a water sensor or water detector that is designed to detect the presence of moisture or water or other liquids. For example, the sensor 14 may rely on the electrical conductivity of water to close a circuit or decrease resistance across two contacts or probes. Each sensor 14 connects to a central module of the vehicle, such as an ECU of the vehicle, either via a wired connection or via a wireless connection or communication. The central module, responsive to processing sensor data from the sensors 14, determines or detects the presence of water or other liquids at one of the sensors 14. Based on multiple parameters, the central module generates an appropriate warning or notification or alert.

For example, when the vehicle is in use (i.e., the vehicle is in operation and/or an occupant is within the vehicle), the notification or alert may include a visual notification (e.g., displayed on one or more displays disposed within the vehicle) and/or an audible notification (e.g., played over speakers disposed within the vehicle). When the vehicle is not in operation, such as when the vehicle is parked and an occupant is not within the vehicle, the notification or alert may include flashing lights (e.g., head lights, taillights, etc.) of the vehicle and/or honking a horn of the vehicle. The notification or alert may also include a wireless communication to a user device of an owner or user of the vehicle. For example, the central module may use wireless communication to push a notification to a smartphone of a user (e.g., via a cellular communication network, via a WI-FI network, via a BLUETOOTH® connection, etc.).

Alternative to or in addition to a notification or alert, the sensing system 12 may take other actions to protect the vehicle 10. For example, the sensing system may determine that one or more windows of the vehicle are open and close the windows responsive to detection of water in the vehicle. Optionally, the system may close a trunk/hood of the vehicle or close a sunroof/moonroof of the vehicle upon detection of water in the vehicle. These actions may be configurable (e.g., by a user of the vehicle).

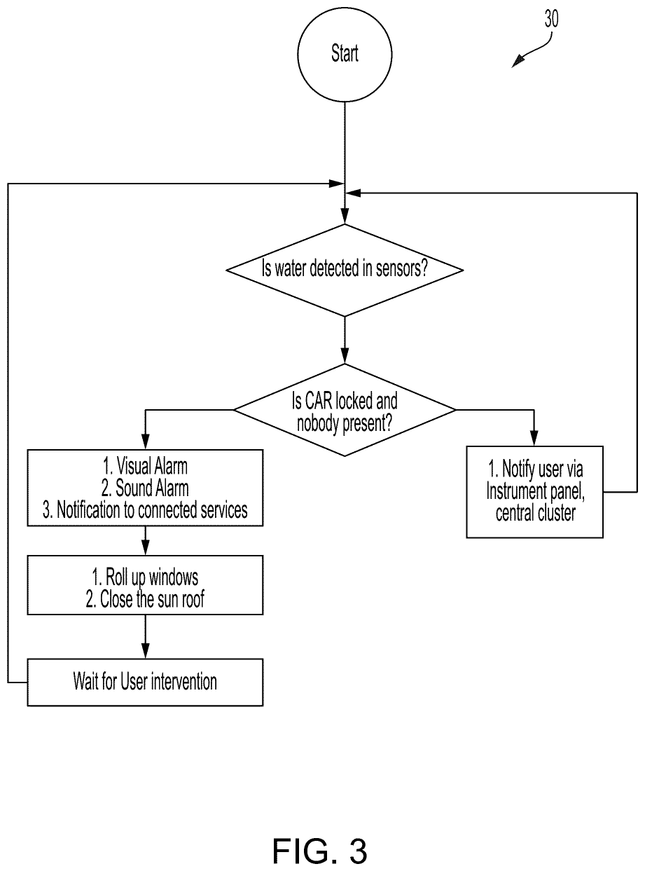

Referring now to FIG. 3, an exemplary flow chart 30 of the sensing system begins by determining whether water is detected by any of the connected sensors. When water is detected, the sensing system may determine whether the vehicle is locked and/or whether any occupants are present within the vehicle. When an occupant is within the vehicle, the sensing system may notify the occupant via an internal display (e.g., at an instrument panel or center console of the vehicle) and/or via an audio alert over the speakers of the vehicle. When an occupant is not within the vehicle, the sensing system may provide an external visual and/or audible alarm (e.g., via flashing lights of the vehicle and/or honking a horn of the vehicle). Additionally, or alternatively, the sensing system wirelessly communicates an alert to any connected devices or services, such as a text message, an email, an application notification, etc., to an owner or registered user of the vehicle. Optionally, the sensing system may close any open windows, sunroofs, moonroofs, or doors when water is detected by the sensor(s). The sensing system may then wait for user intervention before returning to an idle or start state.

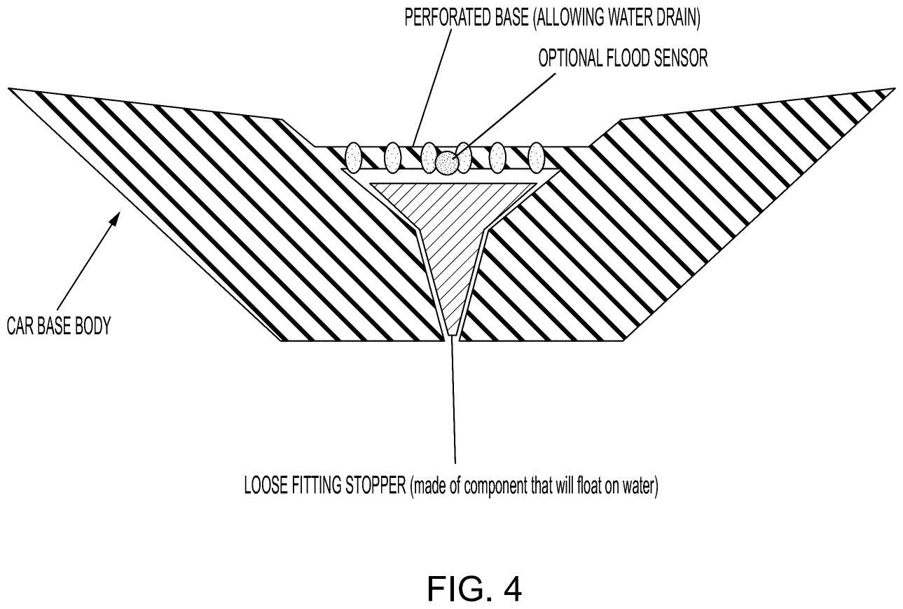

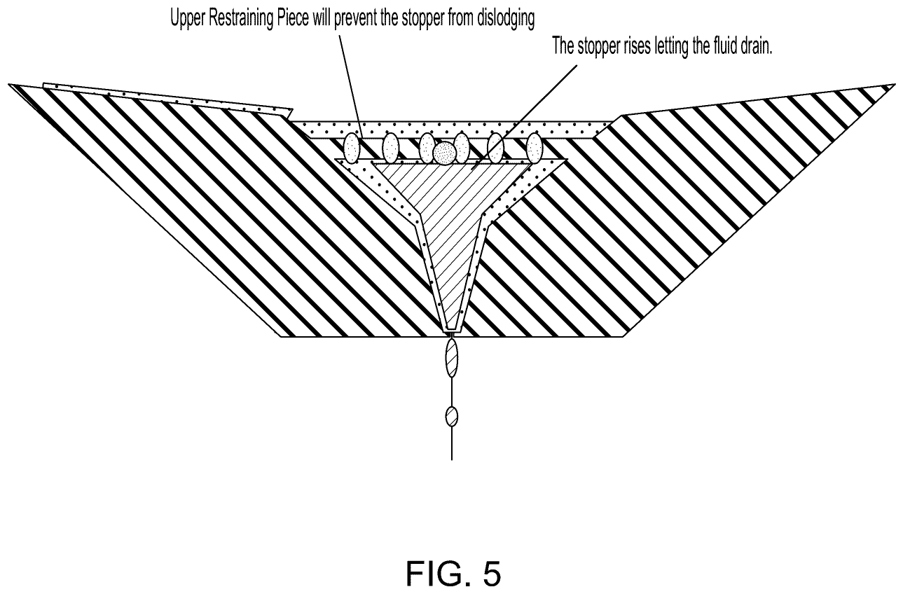

Referring now to FIGS. 4 and 5, in some examples, a vehicle includes a flood mitigation system with a drain or draining system integrated at or near or into the floor of the vehicle. The flood mitigation system may be in addition to the sensing system or alternative to the sensing system. As shown in FIG. 4, the drain may include a perforated base that allows water and other liquids to pass through the floor of the vehicle and into a cavity without allowing most solids to pass. The drain may be plugged via a loose-fitting stopper constructed of a material that is buoyant in most liquids, such as water. When the cavity is empty, the stopper fits snugly into the drain, preventing material from entering the vehicle. As the cavity fills with a liquid, the stopper begins to float, exposing the drain to the liquid in the cavity and allowing the liquid to pass through the drain and out of the vehicle (FIG. 5). An upper restraining piece/plate (e.g., the perforated base) may prevent the stopper from dislodging from the cavity and the drain. The floor or car body surrounding the drain/cavity may be tapered to encourage the flow of liquid to the cavity.

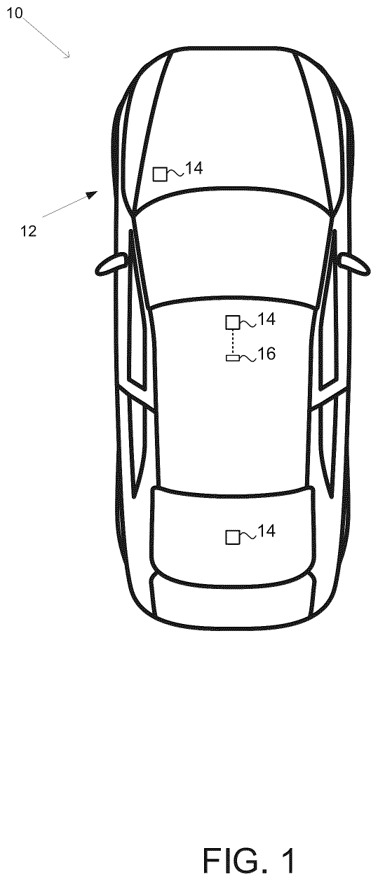

Optionally, and as discussed with respect to FIGS. 1-3, the drainage system may include or may be responsive to a liquid sensor. The liquid sensor may be disposed at the perforated base, at the stopper, within the cavity, or elsewhere on the floor of the vehicle. The liquid sensor alerts the sensing system of the presence of liquid at or near the drain. When the sensor indicates that liquid is present, the system may warn a user or owner of the vehicle via wireless communication (e.g., to a user device or the like), via flashing lights, and/or via an audible alarm (e.g., the horn). In some examples, the system, in response to the sensor detecting presence of liquid, and when the vehicle is stopped (e.g., parked or otherwise not in use), may generate a signal that causes the disconnection (e.g., via an electrical or mechanical switch) of a battery or sensitive components (e.g., ECUs or the like) from wires that carry voltage/current near the drain or other areas where liquid may be present. Such automatic disconnection may prevent damage due to the liquid (e.g., via short circuiting). In other examples, the system may disable starting of the vehicle to ensure that voltage/current is not supplied to wires susceptible to the liquid. The system may reconnect any disconnected electrical components in response to the sensor no longer detecting the presence of liquid and/or via a user override.

Optionally, the drain may be openable and closable responsive to the sensor. For example, the drain may have a default closed state or position and, when the sensor senses water within the vehicle (such as at or near the drain), an actuator may, responsive to an output of the sensor indicative of sensing water at the sensor, raise or move the drain plug to open the drain to allow the water to flow out of the vehicle. When the sensor determines that the water is drained (i.e., the sensor no longer senses water), the system may return the drain plug to its closed state. The actuator may comprise any suitable electro-mechanical actuator that operates to move the drain plug or drain closing element relative to the drain or passageway to open and close the drain. For example, the actuator may raise the stopper of FIGS. 4 and 5 upward, or may move a closure panel at the drain sidewards to expose the opening or passageway, or may rotate a slotted cover panel to align slots of the cover panel with slots of a drain panel to open the drain and to not-align the slots to close the drain.

Thus, the drainage system may automatically drain any liquid that pools in the vehicle. The drainage system may be the primary mechanism for draining the vehicle while the warning system/sensing system attempts to inform/alert a user or owner of the vehicle.

The sensing system may generate the notification or alert responsive in part to whether an occupant is determined to be within the vehicle. The detection of the occupant may be made via a seat sensor or via a driver or occupant monitoring system (such as a cabin monitoring system having a camera that views a driver seat region and/or passenger seat region of the vehicle cabin). For example, an output of an occupant monitoring system (or driver monitoring system or cabin monitoring system) may be based on processing of image data captured by a driver/occupant monitoring camera, such as a camera disposed at a mirror head of an interior rearview mirror and viewing within the interior cabin of the vehicle. The monitoring system may determine whether an occupant is present in the vehicle utilizing aspects of the driver or occupant or cabin monitoring systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. provisional application Ser. No. 63/641,574, filed May 2, 2024 (Attorney Docket DON01 P5156), and/or International Publication No. WO 2023/220222, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
at least one water sensor disposed at an interior of a vehicle equipped with the vehicular sensing system;
an electronic control unit (ECU) comprising electronic circuitry and associated software;
wherein, responsive to receiving at the ECU an output of the at least one water sensor, presence of water within the equipped vehicle is determined; and
wherein, responsive to determination of presence of water within the equipped vehicle, an alert indicating presence of water within the interior of the equipped vehicle is generated.

2. The vehicular sensing system of claim 1, wherein the at least one water sensor comprises a plurality of water sensors disposed at spaced apart locations within the equipped vehicle.

3. The vehicular sensing system of claim 1, wherein the at least one water sensor is at least one selected from the group consisting of (i) disposed at an instrument panel within an interior cabin of the equipped vehicle, (ii) disposed at a center panel within the interior cabin of the equipped vehicle, (iii) disposed at the floor of the interior cabin of the equipped vehicle, and (iv) disposed within a trunk of the equipped vehicle.

4. The vehicular sensing system of claim 1, wherein, responsive to determining presence of water within the equipped vehicle when an occupant is present within the equipped vehicle, the alert is generated via a display disposed within the equipped vehicle.

5. The vehicular sensing system of claim 4, wherein the vehicular sensing system determines whether the occupant is present within the equipped vehicle based at least in part on an output of a cabin monitoring system of the equipped vehicle.

6. The vehicular sensing system of claim 1, wherein, responsive to determining presence of water within the equipped vehicle when an occupant is not present within the equipped vehicle, at least one selected from the group consisting of (i) an exterior light of the equipped vehicle is flashed and (ii) a horn of the equipped vehicle is actuated.

7. The vehicular sensing system of claim 6, wherein the vehicular sensing system determines occupancy of the equipped vehicle based at least in part on an output of a cabin monitoring system of the equipped vehicle.

8. The vehicular sensing system of claim 1, wherein the alert comprises a wireless communication to a user device of a user associated with the equipped vehicle.

9. The vehicular sensing system of claim 8, wherein the alert is communicated to the user device of the user responsive to determining presence of water within the equipped vehicle when an occupant is not present within the equipped vehicle.

10. The vehicular sensing system of claim 1, wherein, responsive to determining presence of water within the equipped vehicle, the vehicular sensing system determines whether an occupant is present within the equipped vehicle, and wherein the vehicular sensing system, responsive to determining that the occupant is not present within the equipped vehicle when presence of water is determined within the equipped vehicle, controls a function of the equipped vehicle.

11. The vehicular sensing system of claim 10, wherein controlling the function of the equipped vehicle comprises closing a window of the equipped vehicle.

12. The vehicular sensing system of claim 10, wherein controlling the function of the equipped vehicle comprises closing a sunroof of the equipped vehicle.

13. The vehicular sensing system of claim 1, further comprising a drain stopper disposed at a drain at the floor of the equipped vehicle, and wherein the drain stopper, when water is not present within the equipped vehicle, blocks the drain, and wherein the drain stopper, when water is determined to be present within the equipped vehicle, adjusts to allow the water to pass through the drain.

14. The vehicular sensing system of claim 13, wherein the at least one water sensor is disposed at the drain in the floor of the equipped vehicle.

15. The vehicular sensing system of claim 13, wherein the vehicular sensing system adjusts the drain stopper responsive to determining presence of water within the equipped vehicle.

16. The vehicular sensing system of claim 1, wherein the at least one water sensor is operable to capture sensor data, and wherein the electronic circuitry of the ECU comprises a data processor for processing sensor data captured by the at least one water sensor.

17. A vehicular sensing system, the vehicular sensing system comprising:
at least one water sensor disposed at a floor of an interior cabin of a vehicle equipped with the vehicular sensing system;
an electronic control unit (ECU) comprising electronic circuitry and associated software;
wherein the vehicular sensing system determines occupancy of the equipped vehicle based at least in part on an output of a cabin monitoring system of the equipped vehicle;
wherein, responsive to receiving at the ECU an output of the at least one water sensor, presence of water within the equipped vehicle is determined;
wherein, responsive to determining presence of water within the equipped vehicle when an occupant is not present within the equipped vehicle, a first alert indicating presence of water within the interior of the equipped vehicle is communicated to a user device of a user associated with the equipped vehicle; and
wherein, responsive to determining presence of water within the equipped vehicle when an occupant is present within the equipped vehicle, a second alert indicating presence of water within the interior of the equipped vehicle is displayed at a display disposed within the equipped vehicle.

18. The vehicular sensing system of claim 17, wherein, responsive to determining presence of water within the equipped vehicle when an occupant is not present within the equipped vehicle, at least one selected from the group consisting of (i) an exterior light of the equipped vehicle is flashed and (ii) a horn of the equipped vehicle is actuated.

19. The vehicular sensing system of claim 17, wherein, responsive to determining presence of water within the equipped vehicle when an occupant is not present within the equipped vehicle, at least one selected from the group consisting of (i) a window of the equipped vehicle is closed and (ii) a sunroof of the equipped vehicle is closed.

20. A vehicular sensing system, the vehicular sensing system comprising:
at least one water sensor disposed at an interior of a vehicle equipped with the vehicular sensing system;
an electronic control unit (ECU) comprising electronic circuitry and associated software;
wherein the vehicular sensing system determines occupancy of the equipped vehicle based at least in part on an output of a cabin monitoring system of the equipped vehicle;
wherein, responsive to receiving at the ECU an output of the at least one water sensor, presence of water within the equipped vehicle is determined;
wherein the vehicular sensing system, responsive to determining that an occupant is not present within the equipped vehicle when presence of water is determined within the equipped vehicle, controls a function of the equipped vehicle; and
wherein controlling the function of the equipped vehicle comprises at least one selected from the group consisting of (i) closing a window of the equipped vehicle, (ii) closing a sunroof of the equipped vehicle, (iii) flashing an exterior light of the equipped vehicle, and (iv) actuating a horn of the equipped vehicle.

21. The vehicular sensing system of claim 20, wherein, responsive to determining presence of water within the equipped vehicle when an occupant is not present within the equipped vehicle, an indicating presence of water within the interior of the equipped vehicle is communicated to a user device of a user associated with the equipped vehicle.

22. The vehicular sensing system of claim 20, further comprising a drain stopper disposed at a drain at the floor of the equipped vehicle, and wherein the drain stopper, when water is not present within the equipped vehicle, blocks the drain, and wherein the drain stopper, when water is determined to be present within the equipped vehicle, adjusts to allow the water to pass through the drain.

23. The vehicular sensing system of claim 22, wherein the at least one water sensor is disposed at the drain in the floor of the equipped vehicle.
